(19) United States
(12) Patent Application Publication
(10) Pub. No.: US 2017/0043568 A1
(43) Pub. Date: Feb. 16, 2017

(54) METHOD OF MAKING A PRODUCT WITH COMPOSITE BODY AND RUBBER SURFACE

(71) Applicant: New Rubber Technologies Holdings, Inc., San Rafael, CA (US)

(72) Inventor: Jagdish Anandjiwala, Tilbury (CA)

(21) Appl. No.: 15/233,702

(22) Filed: Aug. 10, 2016

Related U.S. Application Data
(60) Provisional application No. 62/202,961, filed on Aug. 10, 2015.

(51) Int. Cl. B32B 37/14; B29C 39/02; B32B 7/04; B32B 27/40; B32B 25/08; B29C 39/38; B32B 37/06; B32B 37/15; B29C 65/02; B29C 65/00; B29C 39/24; B29C 39/00; B32B 37/00

(52) U.S. Cl. CPC B32B 37/144; B29C 39/006; B29C 39/02; B32B 7/04; B32B 27/40; B32B 25/08; B32B 37/003; B32B 37/06; B32B 37/15; B29C 65/02; B29C 66/45; B29C 66/712; B29C 39/24; B29C 39/38; B29L 2031/7324

(57) ABSTRACT

A composite product is made by forming an object body comprising a mixture of rubber crumb and binder having a first temperature-dependent cure rate. A surface layer of a vulcanizable rubber compound having a second temperature-dependent cure rate is brought into contact with the object body, and the surface layer and the object body are simultaneously cured at different temperatures so as to match said first and second cure rates such that the surface layer adheres to the object body.

### CROSS REFERENCE

This application claims priority from U.S. provisional application 62/202,961 filed Aug. 10, 2015, which is incorporated by reference herein.

### FIELD OF THE INVENTION

This invention relates to the field of waste rubber technology, and in particular to a method of making useful object from post-consumer elastomer waste, such as rubber crumb.

### BACKGROUND OF THE INVENTION

Modern consumer society generates a large amount of waste rubber from tires and other sources. The waste rubber is typically pulverized into small particles referred to as crumb. This crumb can be turned into useful material, such as matting, as described, for example, in CA2,772,773.

One technique for turning crumb into a useful product involves forming it into a solid body by mixing it with a urethane binder and curing the resulting mixture. Such a product however does not have a very attracting surface, and moreover does not adhere well to surface finishes. The problem faced is that the rubber crumb may cure much faster than the skin or surface finish. This is especially true if the rubber crumb uses a polyurethane (PU) binder because the curing of the polyurethane binder requires water and involves CO₂ gas. In most cases, this creates gas bubbles between the conventionally cured Sulphur based skin and the PU binder.

### SUMMARY OF THE INVENTION

The applicants have found applying a surface layer of vulcanized rubber to a crumb body produced with urethane binder and matching the cure rate of the rubber with that of the body, they are able to obtain good adhesion in the form of a permanent chemical bond between the surface layer and the crumb substrate. Embodiments of this invention allow bonding by adjusting the top and bottom mold temperatures to have the skin and PU body cure simultaneously trapping the gas in the body and allowing good adhesion between the layers.

According to the present invention there is provided a method of making a composite product, comprising forming an object body comprising a mixture of rubber crumb and binder having a first temperature-dependent cure rate; preparing a surface layer of a vulcanizable rubber compound having a second temperature-dependent cure rate; bringing said object body and surface layer into contact; and simultaneously curing the surface layer and said object body at different temperatures so as to match said first and second cure rates such that the surface layer adheres to the object body.

The binder is typically a polyurethane pre-polymer binder applied by tumble blending into the crumb rubber surface using a ribbon blender, or another binder as may be known in the art.

The object surface may consist of conventionally vulcanized elastomer compounds bonded to the crumb rubber body during the formation of the object. The surface material may be prepared by Banbury mixing with subsequent calendaring to produce a preform sheet. The viscosity of the sheet should be 50 to 80 mooney units. A high viscosity is intentionally compounded with respect to the conventionally vulcanized skin in order to prevent the penetration of crumb rubber particles during the molding process. This is readily achievable for those skilled in the art of rubber compounding.

A novel aspect of the procedure is the ability to achieve a chemical bond between the surface layer and the crumb substrate. This is achieved by simultaneous curing of the surface layer and the object body and matching the cure rates. To achieve this, in the case of polyurethane binder, the heated platen for the surface layer should be set 10-20° C. hotter than the object body since the polyurethane cure rate is much faster than that of vulcanized rubber. The thickness of the surface layer also can affect the ability to form an adequate bond. The thickness of the skin is reflective of the need to prevent crumb rubber penetration but allow for enough heat to penetrate to initialize the bond at the interface surface ahead of the polyurethane reaction.

The reaction of polyurethane pre-polymer with latent surface moisture on the rubber crumb brings about the final polymerization of the polyurethane encapsulating the rubber crumb particles and forming a solid object. As a result of the bond formation CO₂ gas and water vapour are produced. Typically the evolution of the gas inhibits the bond formation between the conventionally vulcanized rubber skin and the crumb rubber body with the gas accumulating between the layers causing blisters on the skin.

Cured rubber crumb particles are available for further crosslinking with Sulphur due to the presence of unreacted diene in their polymer chains. To enable a bond to form between the layers without gas accumulation a conventional Sulphur crosslink between the intimate crumb particles and the rubber skin must be achieved prior to the reaction of the polyurethane pre-polymer completing the formation of the composite.

The molding temperature differential allows the Sulphur reaction to commence ahead of the polyurethane reaction allowing the bonding of the two substrates. Since polyurethane cures much faster than the Sulphur cure the differential in temperatures is reflective of this difference. Cure rates for each substrate can be determined with a rheometer cure meter and cure times and temperatures chosen according to the intersection of the cure rates.

These parameters may need final adjustment at the press however to compensate for the thickness of the skin and body portions of the composite object.

Another aspect of the invention provides a composite product, comprising an object body comprising a mixture of at least 95% rubber crumb and binder; and a surface layer of a vulcanizable rubber compound adhering to the object body.

### BRIEF DESCRIPTION OF THE DRAWINGS

This invention will now be described in more detail, by way of example only, with reference to the accompanying drawings:

FIG. 1 shows the process steps involved in making a composite body in accordance with an embodiment of the invention;

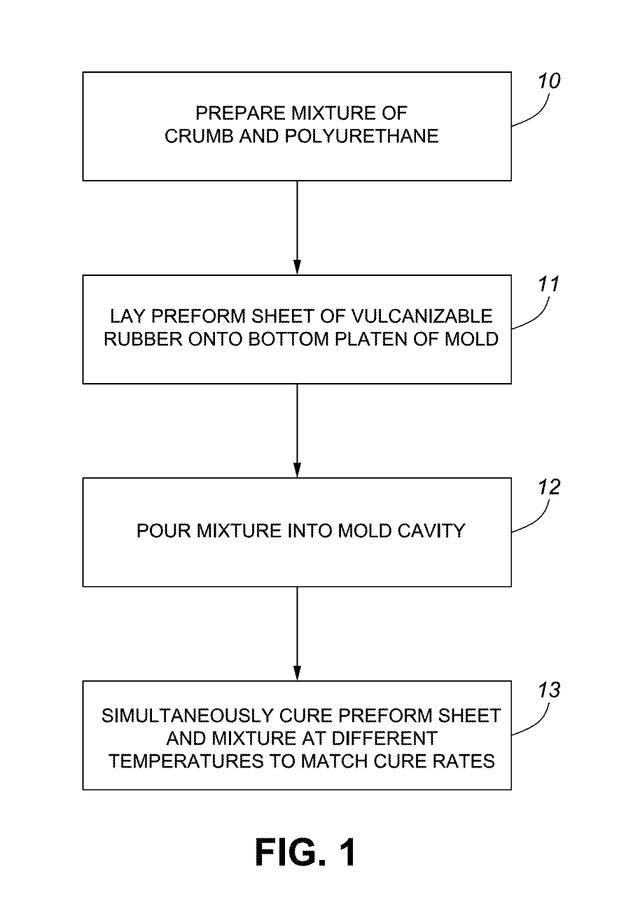

FIG. 2 is a block diagram of the specific example embodiment described;

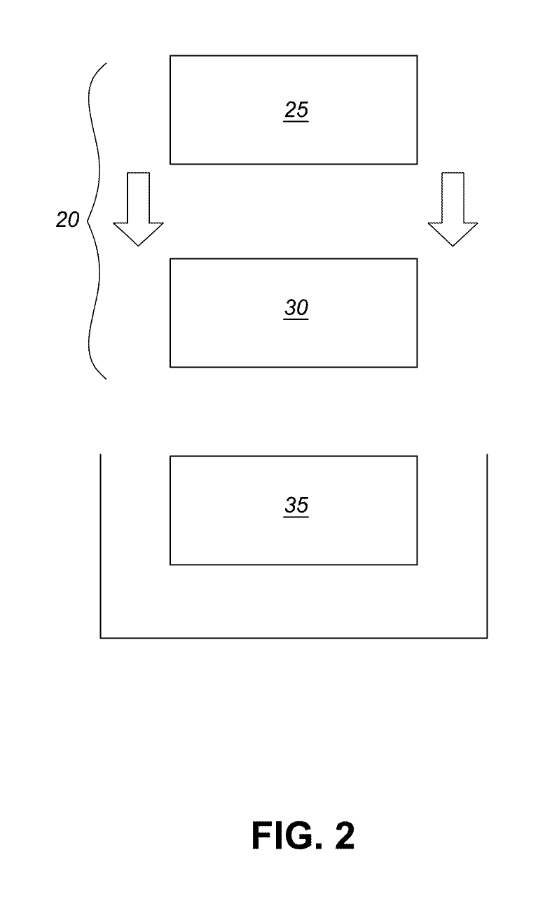

FIG. 3 illustrates a side view of a product made by a conventional method; and

FIG. 4 illustrates a side view of a product made by a method contemplated by the present invention.

### DETAILED DESCRIPTION OF PREFERRED EMBODIMENTS

An example of a specific embodiment is described. A landscaping tile 20 is made by preparing at step 10 a mixture 25 of 1-5% polyurethane pre-polymer binder and 95-99% cured rubber particles, typically tire crumb.

At step 11 a layer of natural or synthetic rubber based compound 30, for example, NR or SBR elastomer, is prepared for vulcanizing in a Banbury mixer and calendered to 2 mm thickness to form a preform sheet of vulcanizable rubber. It is then laid into the cavity of a mold 35. The preferred thickness is 2 mm as it is found this thickness helps the skin resist penetration of the cured rubber particles in the slurry without being economically unrealistic. However an acceptable range is 1-3 mm. The thickness of the preform sheet could vary depending on the requirements of the final product as discussed above.

At step 12, 8-10 lbs. of the mixture 25 prepared in step 10 is then poured into the mold cavity 35 over the layer of natural or synthetic rubber and levelled to form the object body.

At step 13, the preform sheet and the object body are cured together in the mold under pressure, typically in excess of 2000 psi hydraulic pressure. The cure rates of the surface layer and object body are matched by controlling the temperature. Typically the mold has a bottom platen maintained at a temperature of 140-150° C. and a cavity containing the object body maintained at a temperature of 130-140° C. with a temperature differential of at least 10° C. between the bottom platen and the cavity of the mold. The cure time is 8-10 mins.

These parameters ensure that the surface compound cure rate is set such that the surface layer cures simultaneously with the object body. This ensures that a bond forms between the layers without delamination or interstitial gas bubbles. The polyurethane polymerization produces gas so if the cure is not synchronized gas will pool between the layers and cause delamination.

The cure times and temperatures are a specific instance where a 2 mm skin is adhered to a 19-25 mm body. If the temperatures are increased, the cure times shorten or lengthen with a decrease. It will be understood that a differential may need to be applied and the amount of the differential may change depending whether the temperature is hotter or colder than the specific embodiment described above. One skilled in the art will understand that a rheometer cure meter times and temperatures for the two substrates can be determined at specific temperatures and mold temperatures chosen depending on where the cure curves intersect in time. Normal adjustments will have to be taken into effect for the thicknesses of the substrates due to the poor heat transfer rates from the mold surface to the center of the composite.

Embodiments of the invention permit the manufacture of products including matting and landscaping features where a surface distinguishable from the object body is applied during the formation of the body. An example of such a feature would be a landscaping patio tile. The object body typically comprises in excess of 95% by weight of the object is typically produced from a slurry of rubber particulate (crumb) and a binding agent. The binding agent can, for example, consist of a polyurethane pre-polymer binder, or other binder as may be known in the art.

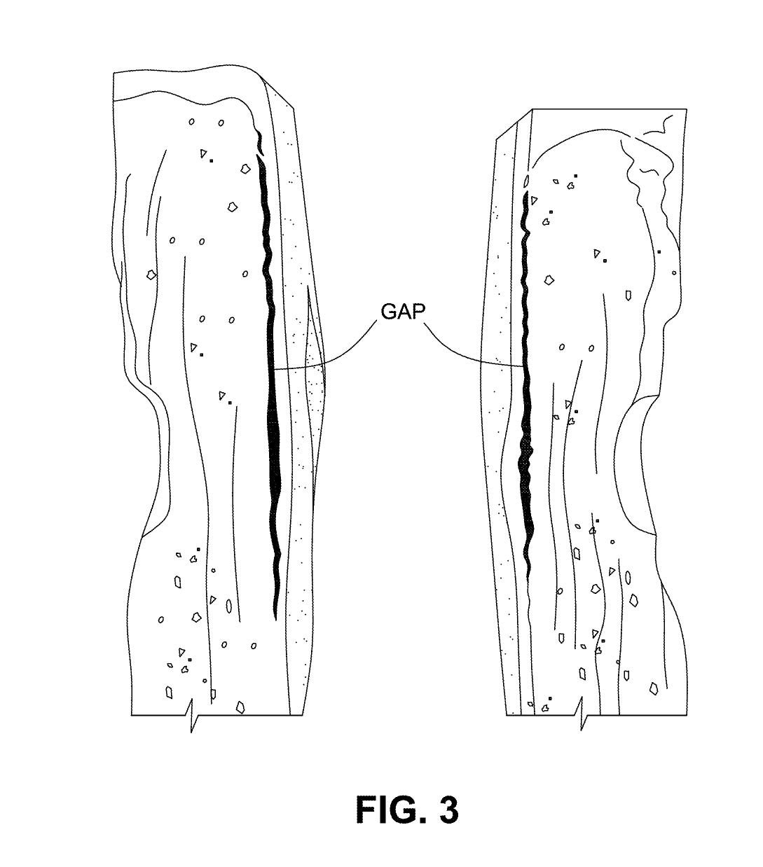

FIG. 3 illustrates a side view of a product made by a conventional method. The delamination can be seen between the surfaces of 25 and 30. The gap where gas accumilated between the surfaces has prevented adhesion.

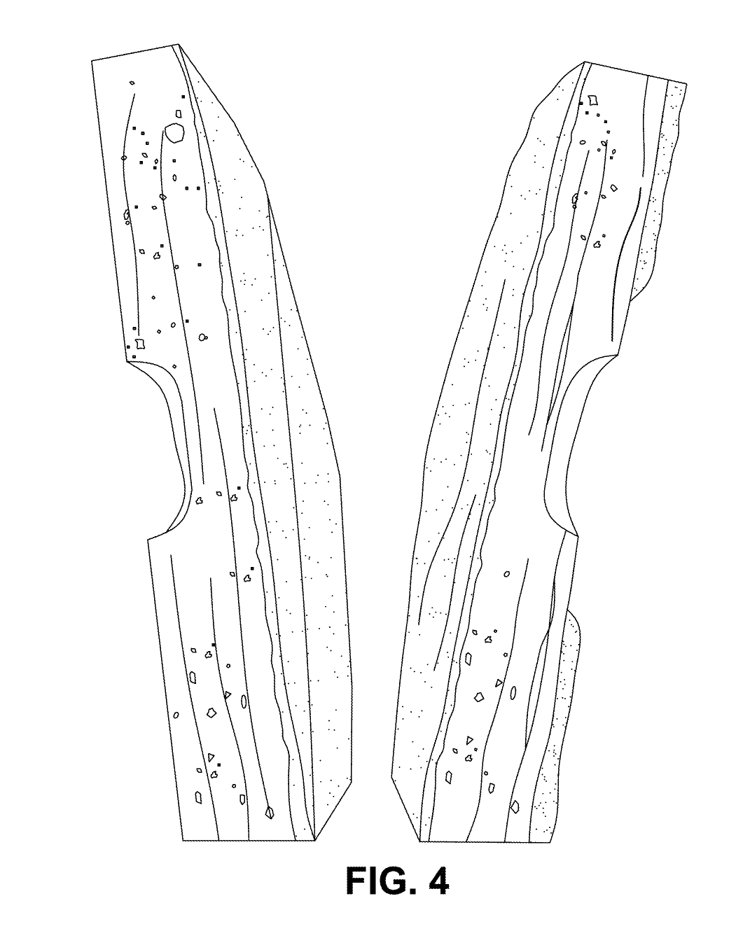

FIG. 4 illustrates a side view of a product made by a method contemplated by the present invention. It can be seen there is no delamination between the surfaces of 25 and 30. The absence of a gap between the surfaces indicates successful adhesion.

1. A method of making a composite product, comprising:
forming an object body comprising a mixture of rubber crumb and binder having a first temperature-dependent cure rate;
preparing a surface layer of a vulcanizable rubber compound having a second temperature-dependent cure rate;
bringing said object body and surface layer into contact; and
simultaneously curing the surface layer and said object body at different temperatures so as to match said first and second cure rates such that the surface layer adheres to the object body.

2. A method as claimed in claim 1, wherein the vulcanizable rubber compound surface layer is formed by Banbury roll mill or extrusion mixing and sheeting to form the preform sheet.

3. A method as claimed in claim 2, wherein the vulcanizable rubber compound preform sheet is applied to a bottom platen of a mold and the rubber crumb and binder is poured into a cavity of the mold over the preform sheet.

4. A method as claimed in 3, wherein the binder is pre-polyurethane.

5. A method as claimed in claim 4, wherein the temperature of the bottom is about 10-20° C. hotter than the cavity of the mold.

6. A method as claimed in claim 5, wherein the preform sheet is about 1-3 mm thick.

7. A method as claimed in claim 5, wherein the bottom platen is maintained at a temperature of 140-150° C. and cavity of the mold is maintained at a temperature of 130-140° with a temperature differential of at least 10° C. between the bottom platen and the cavity of the mold.

8. A composite product, comprising:
an object body comprising a mixture of at least 95% rubber crumb and binder; and
a surface layer of a vulcanizable rubber compound adhering to the object body.

9. A composite product as claimed in 8, wherein the binder is pre-polyurethane.

10. A composite product as claimed in claim 9, wherein the preform sheet is about 2 mm thick.
